(19) United States
(12) Patent Application Publication
(10) Pub. No.: US 2015/0360386 A1
(43) Pub. Date: Dec. 17, 2015

(54) MATERIAL SURFACE DISTRESSING BLADE

(71) Applicant: Armstrong World Industries, Inc., Lancaster, PA (US)

(72) Inventors: BRIAN W. BEAKLER, York, PA (US); MATTHEW S. MYERS, Lititz, PA (US)

(21) Appl. No.: 14/828,598

(22) Filed: Aug. 18, 2015

Related U.S. Application Data
(63) Continuation of application No. 13/442,966, filed on Apr. 10, 2012, now Pat. No. 9,108,335.

(51) Int. Cl. B27M 1/00; B27G 17/04

(52) U.S. Cl. CPC B27M 1/003; B27G 17/04

(57) ABSTRACT

A method of distressing a board is disclosed. In one embodiment, the method comprises: a) supporting the board on a material support, the board having a substantially planar surface; b) providing a blade having a front surface and a curved back cutting surface, the front surface and the curved back cutting surface intersecting to form a curved tip; c) directing the blade and the substantially planar surface into cutting contact; and d) generating relative movement between the blade and the board to distress a portion of the substantially planar surface; and wherein during step d), the blade is maintained in a fixed orientation relative to the substantially planar surface of the board so that an obtuse mount angle is maintained.

### CROSS-REFERENCE TO RELATED APPLICATIONS

This application is a continuation of U.S. patent application Ser. No. 13/442,966 filed on Apr. 10, 2012. The disclosure of the above application is incorporated herein by reference.

### FIELD OF THE INVENTION

The present invention relates to blades, and more specifically, the present invention relates to blades that are configured to distress a surface of a material.

### BACKGROUND

It has become fashionable to subject furniture and other objects/futures or surfaces of walls or flooring of a structure, such as a residence to a design style or technique sometimes referred to as distressing or antiquing. These design styles are intended to “age” the surface of the item or object treated to achieve a unique and/or rustic look. In one aspect of this design style, the surface of the item may be subjected to operations such as sanding, denting, and/or scraping. Typically these types of operations would be performed on furniture or other items, including walls or flooring that are composed of a cellulose-containing material, such as wood and composite board to produce a distressed surface.

Aspects of a distressed surface can include random irregularities formed in the surface of a material, such as variations relating to depth, width and length of the formed surface irregularity by a tool brought into contact with the material surface, as well as random locations along the surface of the material being scraped. In addition, imperfections are typically desirable, and can occur in response to variations, especially abrupt changes, in mechanical properties of a material having a surface to be distressed. Such changes or variations in mechanical properties could relate to density or hardness of the material. Examples include knots, burls and changes in grain direction, such as commonly associated with wood. The desirable appearance of a material surface variation such as a burl, for example, would typically exhibit discontinuities, sometimes referred to as “chattering”, such as formed by a scraping tool in the material surface both prior to and subsequent to a scraping tool encountering the burl.

Known constructions of apparatus have been devised in an attempt to produce materials having the desired aspects associated with a distressed material surface. Such constructions, have included sanding heads having discontinuities formed therein, molded heads that are placed in a pressurized contact with a material surface, as well as embossing drums or plates. However, all known apparatus have failed to produce the desired features associated with a distressed material surface.

A blade that can produce the desired features associated with a distressed material surface in a material would be desirable in the art.

### BRIEF DESCRIPTION OF THE INVENTION

According to an embodiment, a blade includes a body having a front surface and a curved back cutting surface of between about a 12 inch radius and about an 18 inch radius. The front surface has a mount angle of between about 92 degrees and about 98 degrees relative to a material surface of a material facing the back cutting surface. The back cutting surface has a substrate clearance angle of between about 1 and about 3 degrees relative to the material surface. In response to at least one of the blade and the material surface being brought into cutting contact and moved relative to each other, a resulting portion of the material surface is distressed.

According to another embodiment, a blade includes a body having a front surface and a curved back cutting surface of about a 15 inch radius. The front surface has a mount angle of about 96 degrees relative to a material surface of a material facing the back cutting surface. The back cutting surface has a substrate clearance angle of about 2 degrees relative to the material surface. In response to at least one of the blade and the material surface being brought into cutting contact and moved relative to each other, a resulting portion of the material surface is distressed.

According to another embodiment, a method for distressing a surface of a material includes providing a body having a front surface and a curved back cutting surface of between about a 12 inch radius and about an 18 inch radius. The body includes an angle subtended between the front surface and the back cutting surface and being between about 77 degrees and about 85 degrees. The method further includes positioning the front surface between about 92 degrees and about 98 degrees relative to a material surface of a material facing the back cutting surface. The method further includes positioning the back cutting surface between about 1 and about 3 degrees relative to the material surface. The method further includes directing the blade and the material surface into cutting contact, and moving at least one of the blade and the material surface relative to each other.

In one embodiment, the invention may be a method of distressing a board comprising: a) supporting the board on a material support, the board having a substantially planar surface; b) providing a blade having a front surface and a curved back cutting surface, the front surface and the curved back cutting surface intersecting to form a curved tip; c) directing the blade and the substantially planar surface into cutting contact; and d) moving the board relative to the blade in a feed direction so that a portion of the substantially planar surface becomes distressed by the curved tip of the blade; and wherein during step d), the blade is maintained in a fixed orientation relative to the substantially planar surface of the board so that an obtuse mount angle is maintained between the front surface of the blade and a portion of the substantially planar surface that is upstream of the curved tip.

In another embodiment, the invention may be a method of distressing a board comprising: a) supporting the board on a material support, the board having a substantially planar surface; b) providing a blade having a front surface and a curved back cutting surface, the front surface and the curved back cutting surface intersecting to form a curved tip; c) directing the blade and the substantially planar surface into cutting contact; and d) moving the blade relative to the board in a scraping direction so that the curved tip of the blade distresses a portion of the substantially planar surface; and wherein during step d), the blade is maintained in a fixed orientation relative to the substantially planar surface of the board so that an obtuse mount angle is maintained between the front surface of the blade and a portion of the substantially planar surface that is downstream of the curved tip.

Other features and advantages of the present invention will be apparent from the following more detailed description of the preferred embodiment, taken in conjunction with the accompanying drawings which illustrate, by way of example, the principles of the invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a perspective view of an exemplary blade according to an embodiment of the disclosure.

FIG. 2 illustrates a side view of the blade of FIG. 1, according to an embodiment of the disclosure.

FIG. 3 illustrates a front view of the blade of FIG. 1, according to an embodiment of the disclosure.

Wherever possible, the same reference numbers will be used throughout the drawings to represent the same parts.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Provided is a blade for distressing a surface of a material such as by cutting, which is intended to include scraping. Embodiments of the present disclosure permit fabrication of materials having distressed surfaces not previously available, providing a substantially equal distribution of forces applied to the material surface by the blade. The blade is configured to have an extended life cycle. The blade is configured to be positioned in a substantially fixed orientation relative to the material surface, resulting in an optimum cutting contact with the material surface. It is intended that the term cutting contact include scraping, i.e., that the blade is removing shavings and/or chips from the material surface.

For purposes of the disclosure, a distressed surface is intended to exhibit a number of characteristics or aspects. For example, a distressed surface or material surface having a distressed appearance or the like is intended to include random irregularities formed in the surface of a material, such as variations relating to depth, width and length of the formed surface irregularity, such as by at least one embodiment of a blade of the present disclosure brought into contact with the material surface, as well as random locations along the surface of the material being distressed. In addition, a distressed surface is intended to include imperfections that may occur in response to variations, especially abrupt changes, in mechanical properties of a material having a surface to be distressed. Such changes or variations in mechanical properties could relate to density or hardness of the material, Examples include knots, burls and changes in grain direction, such as commonly associated with wood, With a distressed surface, the desirable appearance of a material surface variation such as a burl, for example, would typically exhibit discontinuities, sometimes referred to as “chattering”, such as formed by an embodiment of a blade of the present disclosure. The discontinuities would be manifested in the material surface at locations both prior to and subsequent to an embodiment of a blade of the present disclosure encountering the burl.

It is to be appreciated that another material may include cellulose-containing materials, such as composite board.

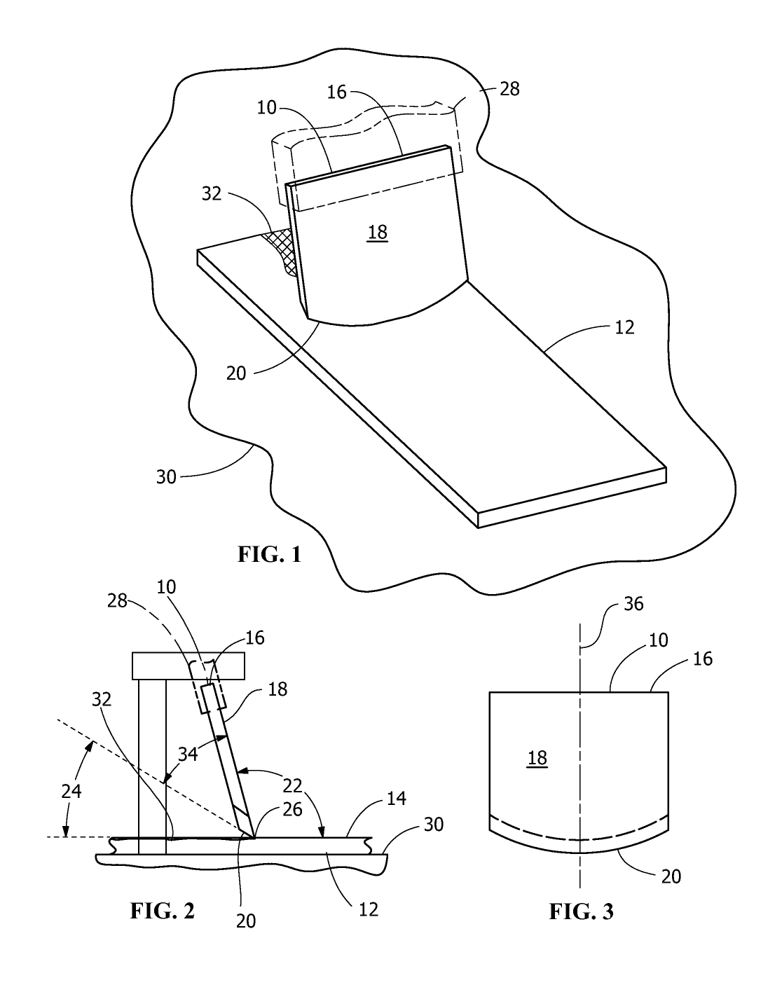

As shown in FIG. 1, a blade 10 of the present disclosure includes a body 16 having a front surface 18 and a back cutting surface 20. Shown opposite back cutting surface 20 is a blade support 28 for blade 10. A material 12, such as a board, includes a surface 14 that is positioned facing back cutting surface 20. As further shown in FIG. 1, material support 30 is provided for supporting material 12. In one embodiment, blade support 28 and material support 30 are interconnected. In use, in response to at least one of blade 10 and material surface 14 being brought into cutting contact and moved relative to each other, a resulting portion of material surface 14 is a distressed surface 32. For purposes of the present disclosure, the terms cutting surface and cutting contact are also intended to include abrading contact, such as scraping surface 14 of material 12.

In one embodiment, blade 10 is constructed of a single, contiguous material, such as a steel, such as M2 tool steel, or other suitable material that maintains an edge, even when subjected to impact, such as between the blade and the material surface. In another embodiment, blade 10 may be formed of several materials joined together, such as by welding, if desired. It is to be understood that the material, as well as the geometry of the blade and the orientation of the blade relative to the surface of a material brought into cutting contact with the blade, contribute to an increase life cycle of the blade of the present disclosure, as compared to other blade constructions.

As shown in FIGS. 2-3, which are not to scale in order to more clearly show and describe features of the present disclosure, blade 10 includes an acute blade angle 34 subtended between front surface 18 and back cutting surface 20, which surfaces intersect at a point or tip 26. In one embodiment, blade angle 34 is between about 77 degrees and about 85 degrees, between about 78 degrees and about 85 degrees, between about 79 degrees and about 85 degrees, between about 80 degrees and about 85 degrees, between about 81 degrees and about 85 degrees, between about 82 degrees and about 85 degrees, between about 83 degrees and about 85 degrees, between about 84 degrees and about 85 degrees, between about 77 degrees and about 84 degrees, between about 77 degrees and about 83 degrees, between about 77 degrees and about 82 degrees, between about 77 degrees and about 81 degrees, between about 77 degrees and about 80 degrees, between about 77 degrees and about 79 degrees, between about 77 degrees and about 78 degrees, between about 78 degrees and about 84 degrees, between about 79 degrees and about 83 degrees, between about 80 degrees and about 82 degrees, between about 80 degrees and about 81 degrees, or any suitable range or sub-range thereof. In one embodiment blade angle 34 is about 77 degrees, about 78 degrees, about 79 degrees, about 80 degrees, about 81 degrees, about 82 degrees, about 83 degrees, about 84 degrees, about 85 degrees, or any suitable sub-range thereof. In another embodiment, the magnitude of blade angle 34 can vary within the above referenced ranges, as a function of distance from a central axis 36. It can be appreciated by virtue of blade angle 34 approaching 90 degrees, versus having an angle of reduced magnitude, that blade 10 contains more material, and is thus a more robust construction.

As further shown in the figures, in one embodiment, curved back cutting surface 20 defines a profile of between about a 12 inch radius and about an 18 inch radius, between about a 13 inch radius and about an 18 inch radius, between about a 14 inch radius and about an 18 inch radius, between about a 15 inch radius and about an 18 inch radius, between about a 16 inch radius and about an 18 inch radius, between about a 17 inch radius and about an 18 inch radius, between about a 12 inch radius and about a 17 inch radius, between about a 12 inch radius and about a 16 inch radius, between about a 12 inch radius and about a 15 inch radius, between about a 12 inch radius and about a 14 inch radius, between about a 12 inch radius and about a 13 inch radius, between about a 14 inch radius and about a 17 inch radius, between about a 15 inch radius and about a 16 inch radius, or any suitable range or sub-range thereof. In one embodiment curved back cutting surface 20 defines a profile that has about a 12 inch radius, about a 13 inch radius, about a 14 inch radius, about a 15 inch radius, about a 16 inch radius, about a 17 inch radius, about an 18 inch radius, or any suitable sub-range thereof. In other embodiments, curved back cutting surface 20 can define any radius or non-radial (e.g., oval) curve falling within this range. In another embodiment, as shown in FIG. 3, the profile of curved back cutting surface 20 is symmetric about central axis 36, although in another embodiment, curved back cutting surface 20 contains no axis of symmetry. That is, the amount or degree of curvature of curved back cutting surface 20 can vary, if desired. This range of size of curved back cutting surface 20 encompasses different amounts of curved back cutting surface 20, similarly corresponding to an amount of penetration or depth of a surface of distressed material surface 32 (FIG. 2) from a “pristine” surface 14 of material 12 for a predetermined amount of force directed between blade 10 and surface 14 of material 12.

As shown in FIG. 2, blade 10 includes an obtuse mount angle 22 subtended between front surface 18 and surface 14 of material 12 facing back cutting surface 20, which surfaces intersect at point or tip 26. In one embodiment, blade angle 34 is between about 92 degrees and about 98 degrees, between about 93 degrees and about 98 degrees, between about 94 degrees and about 98 degrees, between about 95 degrees and about 98 degrees, between about 96 degrees and about 98 degrees, between about 97 degrees and about 98 degrees, between about 92 degrees and about 97 degrees, between about 92 degrees and about 96 degrees, between about 92 degrees and about 95 degrees, between about 92 degrees and about 94 degrees, between about 92 degrees and about 93 degrees, between about 93 degrees and about 97 degrees, between about 94 degrees and about 96 degrees, between about 95 degrees and about 96 degrees, or any suitable range or sub-range thereof. In another embodiment, mount angle 22 is about 92 degrees, about 93 degrees, about 94 degrees, about 95 degrees, about 96 degrees, about 97 degrees, about 98 degrees, or any suitable sub-range thereof. Mount angle 22 defines an angular position or orientation of the front surface 18 of blade 10 with respect to surface 14.

As shown in FIG. 2, blade 10 includes acute substrate clearance angle 24 subtended between back cutting surface 20 and surface 14 of material 12. In one embodiment, clearance angle 24 is between about 1 degree and about 3 degrees, between about 2 degrees and about 3 degrees, between about 1 degree and about 2 degrees, or any suitable range or sub-range thereof. In another embodiment, substrate clearance angle 24 is about 1 degree, about 2 degrees, about 3 degrees, or any suitable sub-range thereof. Substrate clearance angle 24 encompasses a range of angular separation between back cutting surface 20 and surface 14 of material 12 which has been shown to substantially prevent an accumulation of removed material from surface 14 between surface 14 and back cutting surface 20 sufficient to “clog” the space defining the angular separation.

Mount angle 22, blade angle 34, substrate clearance angle 24 and curved back cutting surface 20 associated with blade 10 and surface 14 of material 12 not only exhibit at least the beneficial results separately, as previously identified, but in combination, also unexpectedly results in optimized operation of the blade during cutting contact between blade 10 and surface 14 of material 12 for forming distressed material surface 32. For example, in response to blade 10 encountering changes in mechanical properties of material 12, such as relating to changes or variations in density or hardness of the material 12, blade 10 exhibits discontinuities, sometimes referred to as “chattering”. That is, the discontinuities are manifested in the material surface at locations both prior to and subsequent to blade 10 encountering such discontinuities. As a result, the blade of the present disclosure, when brought into cutting contact and moved relative to a material surface, such as the surface of a cellulose-containing material, unexpectedly includes a resulting portion of the material surface having a distressed appearance. In one embodiment, surface 14 of material 12 is substantially planar. In another embodiment, surface 14 of material 12 is nonplanar. It is to be understood that blade 10 of the present disclosure can be used to distress nonplanar surfaces if the blade angular relationships or parameters previously discussed, such as mount angle 22 and substrate clearance angle 24 can be maintained.

In addition, a distressed surface is intended to include imperfections that may occur in response to variations, especially abrupt changes, in mechanical properties of a material having a surface to be distressed. Such changes or variations in mechanical properties could relate to density or hardness of the material. Examples include knots, burls and changes in grain direction, such as commonly associated with wood. With a distressed surface, the desirable appearance of a material surface variation such as a burl, for example, would typically exhibit discontinuities, sometimes referred to as “chattering”, such as formed by an embodiment of a blade of the present disclosure. The discontinuities would be manifested in the material surface at locations both prior to and subsequent to an embodiment of a blade of the present disclosure encountering the burl.

It is to be understood that since the angular orientations of the blade are relative to the material surface, there is no set orientation of the material relative to horizontal or vertical reference positioning. That is, the blade and material may be positioned such that chips and/or shavings fall away from the material, due to gravity. In one embodiment the blade can be configured to include a “chip breaker”, if desired, as long as the angular relationships between the blade and the material surface, as previously discussed, are maintained.

It is to he appreciated that the amount of force applied between the blade and the material surface can vary widely, depending upon factors including the density or hardness of the material, the speed of the cutting contact of the blade relative to the speed of the material, as well as other factors.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of distressing a board comprising:
a) supporting the board on a material support, the board having a substantially planar surface;
b) providing a blade having a front surface and a curved back cutting surface, the front surface and the curved back cutting surface intersecting to form a curved tip;
c) directing the blade and the substantially planar surface into cutting contact; and
d) moving the board relative to the blade in a feed direction so that a portion of the substantially planar surface becomes distressed by the curved tip of the blade; and
wherein during step d), the blade is maintained in a fixed orientation relative to the substantially planar surface of the board so that an obtuse mount angle is maintained between the front surface of the blade and a portion of the substantially planar surface that is upstream of the curved tip.

2. The method according to claim 1 wherein the board is a board of cellulose-containing material.

3. The method according to claim 1 wherein the blade further comprises a rear surface opposite the front surface, each of the front and rear surfaces being planar, and the front surface being parallel to the rear surface.

4. The method according to claim 1 wherein the obtuse mount angle is between 92° and 98°.

5. The method according to claim 1 wherein in the fixed orientation, a substrate clearance angle is maintained between the curved back cutting surface and a portion of the substantially planar surface that is downstream of the curved tip, the substrate clearance angle being between 1° and 3°.

6. The method according to claim 1 wherein step b) comprises mounting the blade to a blade support that is interconnected to the material support.

7. The method according to claim 1 wherein the blade comprises a central axis and the curved back cutting surface is symmetric about the central axis.

8. The method according to claim 1 wherein the curved back cutting surface has a radius of curvature between 12 inches and 18 inches.

9. The method according to claim 1 wherein step d) comprises scraping the substantially planar surface of the board with the curved tip to remove shavings.

10. The method according to claim 1 further comprising:
wherein the board is a board of cellulose-containing material;
wherein the blade further comprises a rear surface opposite the front surface, each of the front and rear surfaces being planar, and the front surface being parallel to the rear surface;
wherein the obtuse mount angle is between 92° and 98°;
wherein in the fixed orientation, a substrate clearance angle is maintained between the curved back cutting surface and a portion of the substantially planar surface that is downstream of the curved tip, the substrate clearance angle being between 1° and 3°;
wherein step b) comprises mounting the blade to a blade support that is interconnected to the material support;
wherein the blade comprises a central axis and the curved back cutting surface is symmetric about the central axis;
wherein the curved back cutting surface has a radius of curvature between 12 inches and 18 inches; and
wherein step d) comprises scraping the substantially planar surface of the board with the curved tip to remove shavings.

11. A method of distressing a board comprising:
a) supporting the board on a material support, the board having a substantially planar surface;
b) providing a blade having a front surface and a curved back cutting surface, the front surface and the curved back cutting surface intersecting to form a curved tip;
c) directing the blade and the substantially planar surface into cutting contact; and
d) moving the blade relative to the board in a scraping direction so that the curved tip of the blade distresses a portion of the substantially planar surface; and
wherein during step d), the blade is maintained in a fixed orientation relative to the substantially planar surface of the board so that an obtuse mount angle is maintained between the front surface of the blade and a portion of the substantially planar surface that is downstream of the curved tip.

12. The method according to claim 11 wherein the board is a board of cellulose-containing material.

13. The method according to claim 11 wherein the blade further comprises a rear surface opposite the front surface, each of the front and rear surfaces being planar, and the front surface being parallel to the rear surface.

14. The method according to claim 11 wherein the obtuse mount angle is between 92° and 98°.

15. The method according to claim 11 wherein in the fixed orientation, a substrate clearance angle is maintained between the curved back cutting surface and a portion of the substantially planar surface that is downstream of the curved tip, the substrate clearance angle being between 1° and 3°.

16. The method according to claim 11 wherein step b) comprises mounting the blade to a blade support that is interconnected to the material support.

17. The method according to claim 11 wherein the blade comprises a central axis and the curved back cutting surface is symmetric about the central axis.

18. The method according to claim 11 wherein the curved back cutting surface has a radius of curvature between 12 inches and 18 inches.

19. The method according to claim 11 wherein step d) comprises scraping the substantially planar surface of the board with the curved tip to remove shavings.

20. The method according to claim 11 further comprising:
wherein the board is a board of cellulose-containing material;
wherein the blade further comprises a rear surface opposite the front surface, each of the front and rear surfaces being planar, and the front surface being parallel to the rear surface;
wherein the obtuse mount angle is between 92° and 98°;
wherein in the fixed orientation, a substrate clearance angle is maintained between the curved back cutting surface and a portion of the substantially planar surface that is downstream of the curved tip, the substrate clearance angle being between 1° and 3°;
wherein step b) comprises mounting the blade to a blade support that is interconnected to the material support;
wherein the blade comprises a central axis and the curved back cutting surface is symmetric about the central axis;
wherein the curved back cutting surface has a radius of curvature between 12 inches and 18 inches; and
wherein step d) comprises scraping the substantially planar surface of the board with the curved tip to remove shavings.
